(19) United States
(12) Patent Application Publication
(10) Pub. No.: US 2007/0215437 A1
(43) Pub. Date: Sep. 20, 2007

(54) Gas Bearing Substrate-Loading Mechanism Process

(75) Inventor: Valerick Cassagne, Les Ulis (FR)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/571,604

(22) PCT Filed: Jul. 7, 2005
(86) PCT No.: PCT/CH05/00392

§ 371 Date: Mar. 27, 2007

Related U.S. Application Data
(60) Provisional application No. 60/586,645, filed on Jul. 9, 2004.

(51) Int. Cl. B65G 49/06

(52) U.S. Cl. 198/377.04

(57) ABSTRACT

A levitation apparatus for use under vacuum or near vacuum conditions comprises a levitation plate (3) with a plurality of injection points (1) and adjacent suction points (2) for gas, creating an air bearing (4) and thereby supporting a thin plate-like substrate (5). Further embodiments comprise a transport mechanism for supported substrates and/or a tilting mechanism to incline the levitation plate.

### BACKGROUND OF THE INVENTION

The present invention applies to substrate movement in vacuum process devices in general, and to a multitude of plasma enhanced chemical vapor deposition (PECVD) reactors employed in parallel for LCD production in particular. It may also be employed for any other kind of substrate movements in vacuum such as semiconductor wafers, optical and architectural glasses, tool bits and the like and in many different vacuum processes such as etching, sputtering, vapor deposition, chemical vapor deposition and others more. In many vacuum process devices, the substrates are loaded into a process chamber by means of a load lock, so that a vacuum may constantly be maintained in the actual process chamber.

For the loading and unloading of substrates from the load lock into the actual process chamber (such as in semiconductor manufacturing devices) under vacuum conditions, today mostly combinations of loading forks and lifting pins are used. The usage of pins however poses problems with their mechanical reliability and they also tend to disturb the uniformity of the plasma during deposition. Since today's substrate sizes (areas) are growing bigger and bigger, and since the substrates are either becoming thinner and thinner (glass substrates at 0.5 mm and over 2 m² for example) or becoming less and less rigid (polymer substrates, elevated process temperatures), the usefulness of pins and/or forks to transport such fragile substrates is increasingly limited. Furthermore, the use of such mechanical loading and unloading systems requires a minimal height of a vacuum process system (such as a reactor height), which is especially undesirable in the case of PECVD reactors, because they dictate a minimal reactor gap dimension (i.e. the distance between the top electrode and the reactor bottom) which again limits process parameter windows, such as deposition rates. By generally requiring a minimal reactor height, such mechanical loading and unloading systems also increase the footprint (overall height) when several such vacuum deposition systems are used in parallel and on top of each other. The use of mechanical loading and unloading devices often also introduces particle sources and thus tend to increase the number of defects in the so manufactured products.

### RELATED ART

Transporting glass substrates on air cushion conveying devices is known in the art. U.S. Pat. No. 3,607,198 generally addresses an apparatus for pneumatically supporting a plate-like substrate under atmospheric conditions. U.S. Pat. No. 6,220,056 provides a device for handling thin plate glass in machining facilities, comprising at least two plates with flat surfaces arranged parallel to each other at a distance sufficient for accommodating the pane of glass without contact. The surfaces show numerous gas passages.

However, prior art does not address a solution to all of the problems mentioned above simultaneously (like the pin/fork solutions) and/or it does not teach how to transport fragile large area substrates under vacuum conditions. Generally “vacuum conditions” and “transporting on air” seem to contradict each other. However, as the invention described can show, clear advantages can be achieved over Prior Art.

### SUMMARY OF THE INVENTION

A levitation apparatus for use under vacuum or near vacuum conditions comprises a levitation plate with a plurality of injection points and adjacent suction points for gas, creating an air bearing and thereby supporting a thin plate-like substrate. Advantageously the suction and injection points are arranged alternatively and are respectively connected to form a levitation or suction network. Further embodiments comprise a transport mechanism for substrates and/or a tilting mechanism to incline the levitation plate.

### BRIEF DESCRIPTION OF THE DRAWINGS

FIG. 1 shows in detail an arrangement of injection and suction points in a levitation plate.

FIGS. 2a and 2b show two embodiments of injection and suction point distribution according to the invention.

FIG. 2c shows an example for a gas and vacuum network.

FIGS. 3a and 3b show a transfer with two robot configurations (side view)

FIGS. 3c and 3d show a transfer with two robot configurations (top view)

### DETAILED DESCRIPTION OF THE INVENTION

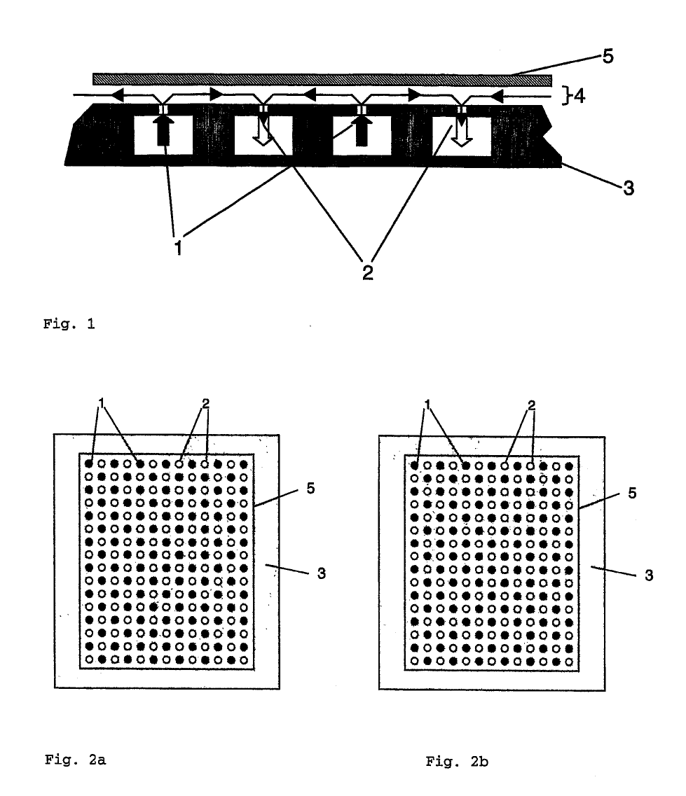

The present invention overcomes the problems described above—how to reliably transport fragile large area substrates between a load lock chamber and a vacuum reactor and how to have minimum impact on the reactor size and its process uniformity—by using uniform air or gas bearing (levitation) for transport under vacuum conditions. Glass substrates with density of 2700 kg/m3 and a thickness of 0.5 to 3 mm have a weight of 0.135 g to 0.81 g per square centimeter. This represents a pressure from 13 to 80 Pascal (0.13 to 0.8 mbar). Thus a gas under a pressure from 0.13 to 0.8 mbar can lift such a substrate. According to FIG. 1 a levitation gas is injected via injection points 1 and is further pumped back out of the vacuum chamber via suction points 2 at a lower pressure (the pressure difference between injection and suction being larger than the minimum necessary for levitation). This way the substrate 5 is supported on an air bearing 5. Injection points 1 and suction points 2 are located in levitation plate 3, which can be a robot arm or the process chamber bottom.

In order to maintain a sufficiently high vacuum in the load lock and in the reactor(s) during the levitation for loading and unloading of the substrates, the bulk of the gas needed for the substrate transport by levitation is readily evacuated through the carefully placed suction points and all remaining levitation gas is easily removed from the system before the actual vacuum process (such as deposition or etching) takes place. The gas is mainly evacuated through the suction points and the gas leak at the edges of the substrates is limited. In case of a stationary vacuum process, the gas injection and thus the levitation can be stopped. In case of a continuous movement during the vacuum process—such as in an in-line process where the substrate might initially or finally be rolled to or from a cylindrical roll, an inert gas can be used. Accordingly—and contrarily to conventional wisdom—gas cushion transport of fragile large area substrates can be achieved in vacuum systems.

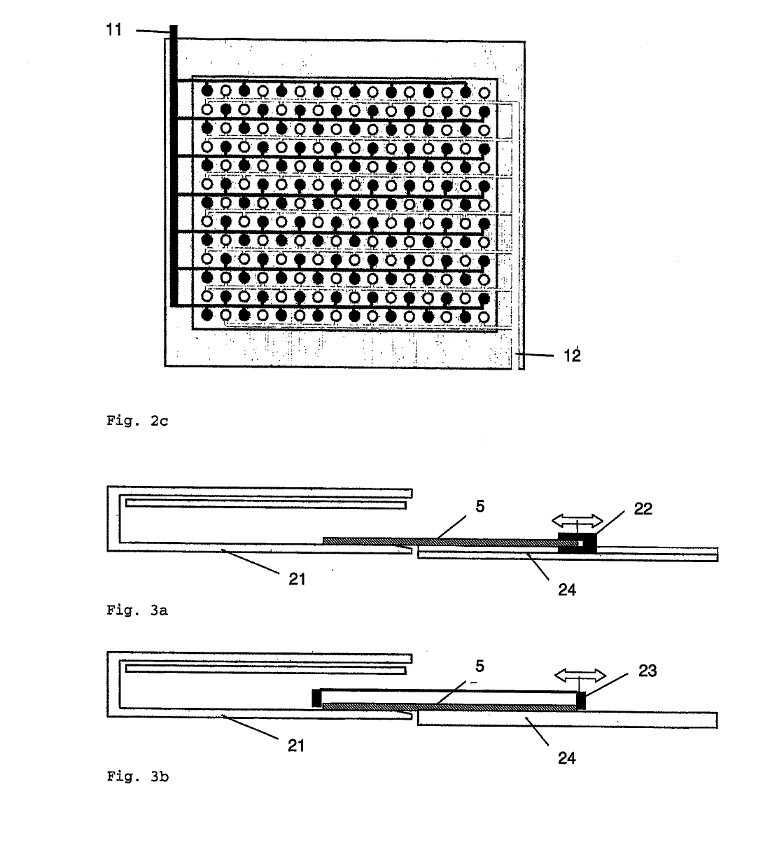

FIGS. 2a and 2b show two possible arrangements of suction points 2 and injection points 1 in a levitation plate 3. A circumferential line shows the possible position of a substrate 5.

FIG. 2c shows a preferred embodiment of the present invention by arranging the injection and suction points alternatively so that overall uniformity is given. Consequently, a high gas flow on the substrate side is avoided and consequently turbulences, which would cause unwanted particle movement, are avoided also. The size and spacing of the injection and suction holes, the injection and suction pressure and the nature of the levitation gas vary, and are very much dependent on the substrate material and the thickness of the substrate. Preferably suction holes are connected to establish a vacuum (suction) network 12 and the injection holes are connected to Establish a levitation gas network 12.

### EXAMPLE 1

a glass substrate with a density of 2700 kg/m3 and a thickness of 0.5 mm is levitated for a loading/unloading action by injection of nitrogen, which has a pressure of 100 Pa in the injection grooves, 50 Pa under the substrate and 20 Pa in the suction grooves.

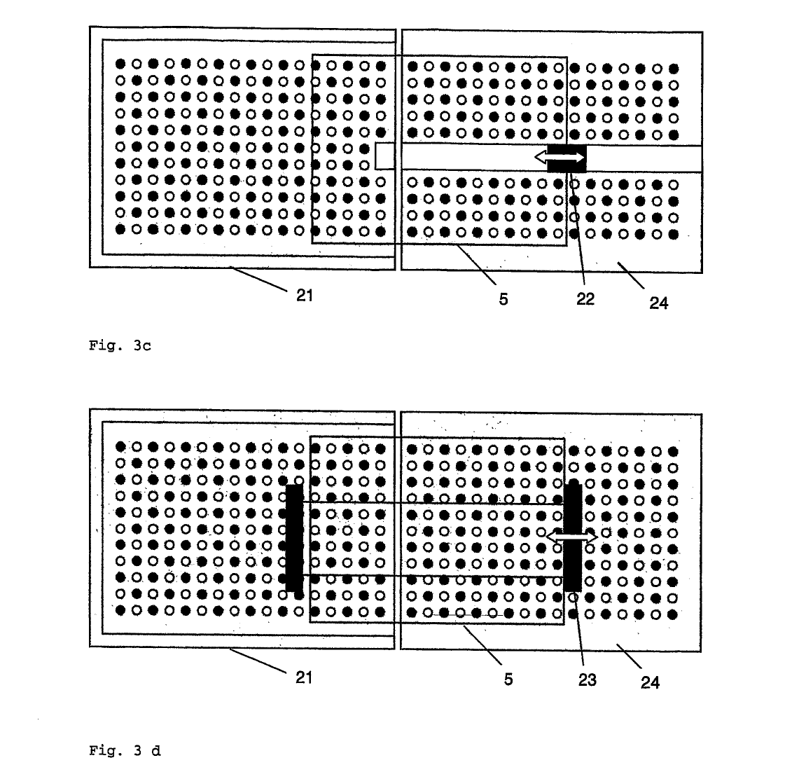

Since suction cups cannot be used in vacuum, FIGS. 3a and 3b show a robot with robot table 24 with a clamping system 22 (gripper), which is used in a preferred embodiment to move the substrate 5 once it is levitated by the gas cushion described above, e.g. in and out of a process chamber (process chamber bottom 21). Due to the levitation of the substrate 5 and since the loading and unloading movement is in a substantially horizontal plane, only very small forces are needed to overcome the inertia of the substrate and thus to move it to its final loaded and unloaded positions. Alternatively, if the substrate is thick and stiff enough, pushing substrate from the edge is also possible (FIG. 3b, pushing/pulling system 23).

FIGS. 3c and 3d each show an embodiment of the invention, wherein both, the vacuum process chamber itself (left), and a table (robot table 24) belonging to a transport robot assembly (right) are equipped with the injection and suction means for levitation in vacuum as described above. Once the robot has moved to its loading and unloading position in front of the then opened process chamber, the substrate is levitated and then slid in and out of the reactor by a gripper (clamping system 22) or a pushing/pulling system 23. In one embodiment, this gripper is accommodated into a groove, which is machined into both of the air bearing tables, to allow for a smooth, even, straight and substantially horizontal loading and unloading movement.

It is emphasized that all of the elements shown in FIGS. 1 to 3 are enclosed by a large receptacle or vacuum recipient (not shown) so that all parts in FIG. 3 a-d are under vacuum. This large receptacle may lead to a load lock (also not shown) or may include a plurality of process chambers.

In other embodiments, clamping systems may also be employed on the substrate sides parallel to the substrate movement or even means of movement by rolls, magnets and electrostatic devices may be deployed to advance the substrate once it is levitated by gas.

In one embodiment of the present invention, the robot table and the process chamber may each or both be slightly inclined by a tilting mechanism during loading and unloading actions, so that the substrate movement is supported or caused by gravity and so that the substrate is consequently kept flat.

Once the reactor is loaded or unloaded with a substrate, the transfer robot assembly may move in a plurality of directions and axes to serve a load lock chamber, further reactor chambers or an array of any such chambers.

### FURTHER ADVANTAGES OF THE INVENTION

By eliminating all movable parts in the vacuum reactor, a high degree of reliability is gained: mechanical failure is avoided and no parts are present which could corrode or which could be particle sources. By eliminating lifting pins, smaller reactors of less height and thus with a smaller gap and a higher deposition rate may be constructed. Since the reactor height is reduced, more such reactors can be stacked on top of each other and be used in parallel, which increases overall system productivity. Since nearly no forces are exercised on the levitated substrate, less damage will occur (breaking of glass substrates for example). Since the injection and the suction holes at the bottom of the reactor can be made significantly smaller than the holes for pins, a far more uniform plasma can be obtained. Since no pins are present, they cannot interfere with the active regions of a manufactured LCD display. This allows to arbitrarily defining display sizes to be made out of a single large substrate independently from pin locations. Furthermore the system has the overall effect of a “vacuum cleaner”: by readily removing the gas which is introduced for levitation, unwanted particles, which may have been present independently of the loading/unloading process, are removed through the suction system.

### REFERENCE NUMERALS

1 injection points
2 suction points
3 levitation plate (robot arm or process chamber bottom)
4 air bearing
5 substrate
11 levitation gas network
12 vacuum (suction) network
21 process chamber bottom
22 clamping system
23 pushing/pulling system
24 robot table

1. Levitation apparatus for use under vacuum or near vacuum conditions comprising a levitation plate (3) with a plurality of injection points (1) and adjacent suction points (2) for gas, creating an air bearing (4) and thereby supporting a thin plate-like substrate (5).

2. Apparatus according to claim 1, wherein the suction points (2) and injection points (1) are arranged alternatively in the levitation plate (3).

3. Apparatus according to claims 1 to 2, wherein injection points (1) are connected to form a levitation gas network (11).

4. Apparatus according to claims 1 to 3, wherein suction points (2) are connected to form a suction network (12).

5. Apparatus according to claims 1 to 4, further comprising a transport robot for moving the plate-like substrate (5).

6. Apparatus according to claim 5, wherein the movement of the substrate (5) is caused by a gripper accommodated in a groove in the robot table (24) or process chamber bottom (21).

7. Apparatus according to claim 5, wherein the movement of the substrate (5) is caused by a pushing/pulling system (23).

8. Apparatus according to claims 1 to 4, wherein a tilting mechanism at the levitation plate allows to initiate or support a movement of substrate (5).

9. Robot arm for transporting a thin plate-like substrate comprising an apparatus according to claim 1 to 8.

10. Process chamber bottom comprising an apparatus according to claim 1 to 8.
